(19) United States
(12) Patent Application Publication
(10) Pub. No.: US 2026/0316200 A1
(43) Pub. Date: Oct. 15, 2026

(54) METHOD FOR MANUFACTURING AN IMPELLER AND IMPELLER

(71) Applicant: CRYOSTAR SAS, HESINGUE (FR)

(72) Inventor: Anny MURAD-BICKARD, HESINGUE (FR)

(21) Appl. No.: 19/100,398

(22) PCT Filed: Aug. 23, 2023
(86) PCT No.: PCT/EP2023/025383

§ 371 Date: Jan. 31, 2025

(30) Foreign Application Priority Data
Aug. 24, 2022 (EP) 22315191.1

(51) Int. Cl. B23P 15/00; B22F 5/00; B22F 7/08; B22F 10/25; B33Y 10/00; B33Y 80/00; F04D 29/30

(52) U.S. Cl. CPC B23P 15/006; B22F 5/009; B22F 7/08; B22F 10/25; F04D 29/30; B33Y 10/00; B33Y 80/00; F05D 2230/10; F05D 2230/40; F05D 2300/615

(57) ABSTRACT

A method for manufacturing an impeller, in particular, for a turbomachine, the impeller having a closed design, and the impeller comprising a first part, a second part and vanes arranged between the first part and the second part, forming channels in the impeller, the method comprising the following steps: providing a raw-stage of the impeller, comprising the first part the vanes arranged at the first part; providing a filling material in spaces between the vanes; forming, at a top surface of the filling material and at top sides of the vanes, the second part, by means of cold spraying; and removing the filling material.

The present invention relates to a method for manufacturing an impeller in a closed design, for example, for a turbo machine, to such an impeller and to a turbo machine with such an impeller.

### BACKGROUND

Turbo machines like compressors, expanders and pumps can be used in different applications. For example, in cryogenic applications, i.e. applications with process gases at cryogenic temperatures, e.g., plants for air separation or the like, cryogenic turbo machines like turbo expanders and/or compressors are often used. Such turbo machines typically comprise an expander impeller and/or a compressor impeller, which are fixed on a shaft.

Impellers for such turbo machines can have an open design or a closed design, in which vanes of the impeller form channels. An advantage of the closed design is a higher isentropic efficiency of the impeller. In certain process conditions, often at very low specific speeds and high rotational speeds, an ideal geometry of such channels leading to the best efficiency cannot be machined by conventional subtractive techniques. The impeller has to be left open (i.e., the impeller is in open design) in these cases, involving a loss of efficiency. It is therefore an object of the present invention to provide an improved impeller in the closed design.

### DISCLOSURE OF THE INVENTION

This object is achieved by providing a method for manufacturing an impeller, an impeller and a turbo machine with the features of the independent claims. Embodiments of the invention are the subject of the dependent claims and of the description that follows.

The invention relates to manufacturing an impeller in the closed design, for a turbomachine like an expander, compressor or pump. Such an impeller comprises a first part (or shroud or plate; it can be a bottom part), a second part (or shroud or plate; it can be a top part) and vanes arranged between the first part and the second part, forming channels (for operating medium) in the impeller.

As mentioned above, an ideal geometry of such channels leading to the best efficiency, typically, cannot be machined by conventional subtractive techniques. The impeller has to be left open, i.e., the impeller is in open design, in these cases. Additive manufacturing techniques allow to build impellers in closed design (closed impellers). However, typical additive manufacturing techniques involve a strong heating of the part which is either being built entirely by additive manufacturing (PBF-SLM, Powder Bed Fusion, Selective Laser Melting) or partially by adding a function on a wrought component (DED, Direct Energy Deposition, processes). Such strong heating is a problem to build downskin surfaces because the heat must be evacuated. Otherwise, the materials burn and form ledges and dross. Therefore, supports can be used; however, supports are difficult to remove in non-accessible channels and, assuming removal is successfully achieved, the surface finish which is left has typically a surface roughness Ra of higher than 10 μm. This is also the case with low angle downskin surfaces which can sometimes be built without supports. Upskin surfaces are typically also too rough.

Brazing can be used to bond a wrought open impeller (e.g., the mentioned first part with the vanes) which has been milled with a separate shroud (like the mentioned second part) which is turned as well (e.g., milling with a lathe). However, brazing is not applicable to the aluminum alloys like the strongest ones and remains difficult with titanium alloys because the brazing interface is very prone to defects and remains a weak point.

It has turned out that cold spraying (or cold welding) techniques, for example, can be used to obtain an additively manufactured shroud (the second part) on an, e.g., wrought, open impeller (the first part with the vanes) without involving a strong heating of the part. Such lack of heat allows using filling materials like soluble materials which tether the sprayed material. Further, it has turned out that no weak points at the interface between the two materials occur because the interface shape can be customized according to needs when using such two part approach. This allows manufacturing of closed impellers with a surface finish of internal channels, i.e., the inner surface of the channels, at downskin and upskin presenting a surface roughness Ra in the order of magnitude of 1.6 μm and a surface roughness Rt in the order of magnitude of 10 μm as built and prior to any subsequent, optional, surface treatment.

In view of this, a multi-step method for manufacturing an impeller is proposed. In a first step, a raw-stage of impeller part is provided, the impeller (in the raw-stage) comprising the first part and the vanes arranged at the first part. This first part can also be called a bottom part as it will typically be arranged at working surface with this part downside. In this raw-stage, the impeller has an open (or semi-open) design, as there is no first (or top) part.

The raw-stage of the impeller is provided, in an embodiment, as wrought material part. For example, the raw-stage of the impeller is made of one of the following materials: aluminum, aluminium alloy, titanium, titanium alloy, nickel, nickel allow, stainless steel.

At least part of inner surfaces of the channels to be formed (i.e., surfaces of the first part, which surfaces are located between the vanes, and side surfaces of the vanes) are machined to a final contour. Such final contour can be the contour the surfaces shall have in the final impeller (preferably, after some further surface processing). And the top sides of the vanes (i.e., the sides of the vanes onto which the second part is to be added), are pre-machined. Pre-machining will not result in a final contour but there will remain some material to be removed by further machining. In addition, other remaining surfaces can be pre-machined.

The top sides of the vanes can, in embodiments, have one of the following final contours: a rectangular geometry, a flared geometry, a geometry with side gaps or a full gap. These geometries will result in different adhesion surfaces for the second part to be added later. Further details for these geometries will be explained with respect to the Figures. Preferably a geometry with side gaps or a full gap between the vanes have the advantage, that the maximum stresses in operation are not located at all in the interface between wrought material and sprayed material.

In a further step, a filling material, preferably, a soluble material, is provided in spaces between the vanes. These spaces between the vanes (and surfaces of the first part, which surfaces are located between the vanes) are to become inner surfaces of the channels (preferably, after some further surface processing). This filling material is, preferably, provided such that a top surface of the filling material (i.e., a surface which is oriented towards the second part of the impeller to be added), or at least part of this surface, has a contour as this second part later shall have. In addition, the top sides of the vanes should then have a final contour such that the second part can be added directly.

This will be achieved by the following steps (which can be also declared as sub-steps): First, the spaces between the vanes will be filled with the filling material, such that the filling material exceeds the top sides of the vanes, or at least reaches the top side. Note that the top sides of the vanes are, only pre-machined yet. Then, the top sides of the vanes will be machined to the final contour, and the filling material will also be machined at the top surface (or at at least part of it) to a contour the second part is intended to have.

The advantage of that the filling material and the base material surfaces both are machined in the same machining operation is to provide the desired fillet radius for the channel and a sufficient area of contact between base material and sprayed material.

In addition, remaining filling material (if any is present) can be removed from the top sides of the vanes to achieve the final contour; etching can be used here, for example.

In a further step, at a top surface of the filling material and at the top sides of the vanes, the second part is formed, preferably by means of cold spraying. Cold spraying (CS) or gas dynamic cold spraying is a coating deposition method. Solid powders (e.g., 1 to 50 micrometers in diameter) can be accelerated in a supersonic gas jet to velocities up to, e.g. mach 4. During impact with the substrate, particles undergo plastic deformation and adhere to the surface. To achieve a uniform thickness, the spraying nozzle can be scanned along the substrate. The kinetic energy of the particles, supplied by the expansion of the gas, is converted to plastic deformation energy during bonding. Unlike thermal spraying techniques, e.g., plasma spraying, arc spraying, flame spraying, or high velocity oxygen fuel (HVOF), the powders are not melted during the spraying process.

In an embodiment, the second part, obtained by means of cold spraying in step, is made of the same material as the raw-stage of the impeller or has a chemical composition compatible with a strong bonding with the material of the raw-stage of the impeller. This ensures sufficient stability of the final impeller.

In an optional step, the impeller can be heat-treated (before removing the filling material). In a further step, the filling material is removed, for example, by means of dissolving the filling material. For example, aluminum alloy like 7075 can be used when the substrate material (for the first part) is a titanium alloy. Such aluminum alloy can be dissolved by NaOH, for example. In an optional further step, the impeller can be heat-treated (again) after removing the filling material. Such heat-treatment can be useful to release residual stresses or to create a diffusion between the cold sprayed material and the wrought material to increase the interfacial resistance.

Preferably, in a further step, after removing the filling material, post-processing of inner surfaces of the channels can be performed, preferably comprising at least one of: abrasive flow machining, hirtisation (hirtisation is based on a combination of electrochemical pulse methods, hydrodynamic flow and particle assisted chemical removal and surface treatment; the material-specific treatment media used produce a gentle surface finishing effect; there are no harsh mechanical processing steps), micro machining. In this way, the surface can be further improved.

The invention also relates to an impeller obtained by a method as described above, and to a turbomachine comprising such impeller.

Further advantages and embodiments of the invention will become apparent from the description and the appended figures.

It should be noted that the previously mentioned features and the features to be further described in the following are usable not only in the respectively indicated combination, but also in further combinations or taken alone, without departing from the scope of the present invention. For example in a different approach, the pre-machining steps of the top side of the vanes or of at least part of inner surface of the channels to a final contour, before providing the filling material can be maybe avoided.

### SHORT DESCRIPTION OF THE FIGURES

FIG. 1 illustrates a turbo machine with impellers according to an embodiment of the invention.

FIG. 2 illustrates an impeller according to a further preferred embodiment of the invention.

FIG. 3 illustrates an impeller in open design.

FIG. 4 illustrates a method according to a preferred embodiment of the invention in a flow diagram.

FIG. 5 illustrates part of an impeller according to a further embodiment of the invention.

FIGS. 6a and 6b illustrate parts of an impeller according to a further embodiment of the invention.

FIG. 7 illustrates part of an impeller according to a further embodiment of the invention.

FIG. 8 illustrates part of an impeller according to a further embodiment of the invention.

FIGS. 9a, 9b and 9c illustrate parts of an impeller according to a further embodiment of the invention.

FIG. 10 illustrates part of an impeller according to a further embodiment of the invention.

FIGS. 11a, 11b and 11c illustrate parts of an impeller according to a further embodiment of the invention.

### DETAILED DESCRIPTION OF THE FIGURES

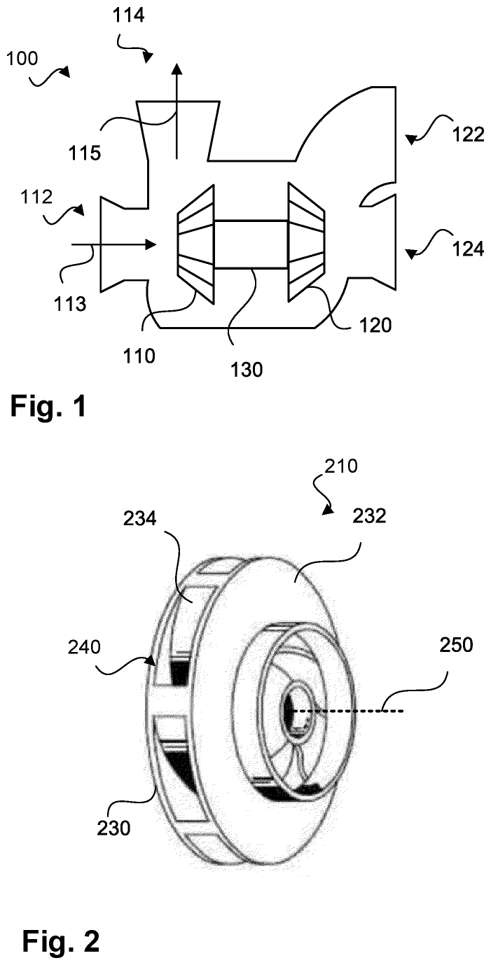

FIG. 1 schematically illustrates a turbo machine 100 according to a preferred embodiment of the invention. The turbo machine 100, e.g., a cryogenic turbo machine is, by means of example, configured as a compressor and an expander, i.e., both are combined in one turbo machine. Turbo machine 100 comprises, hence, two impellers, an impeller 110 and an impeller 120, both mounted on a shaft 130. The turbo machine 100 comprises channels 112 and 114 on the side of the impeller 110, the channels used respectively as inlet channel and outlet channel for the operating medium or fluid, see arrow 113, to be compressed and afterwards be led out, see arrow 115. The turbo machine 100 further comprises channels 122 and 124 on the side of the impeller 120, the channels used respectively as inlet channel and outlet channel for the operating fluid to be expanded. Thus, the impeller 110 is a compressor impeller and the impeller 120 is an expander impeller.

FIG. 2 schematically illustrates an impeller 210 according to a further preferred embodiment of the invention. While the impellers 110, 120 in FIG. 1 are shown schematically, impeller 210 is shown as a closed impeller, i.e., an impeller in closed design. Impeller 210 comprises multiple vanes 234, which are enclosed by two shrouds or plates 230 and 232. In this way, channels 240 are formed between two of such vanes and the plates. The impeller 210 comprises a rotation axis 250. As can be inferred from FIG. 2, machining of such channels 240, in particular, in inner areas, might be complicated or not possible at all.

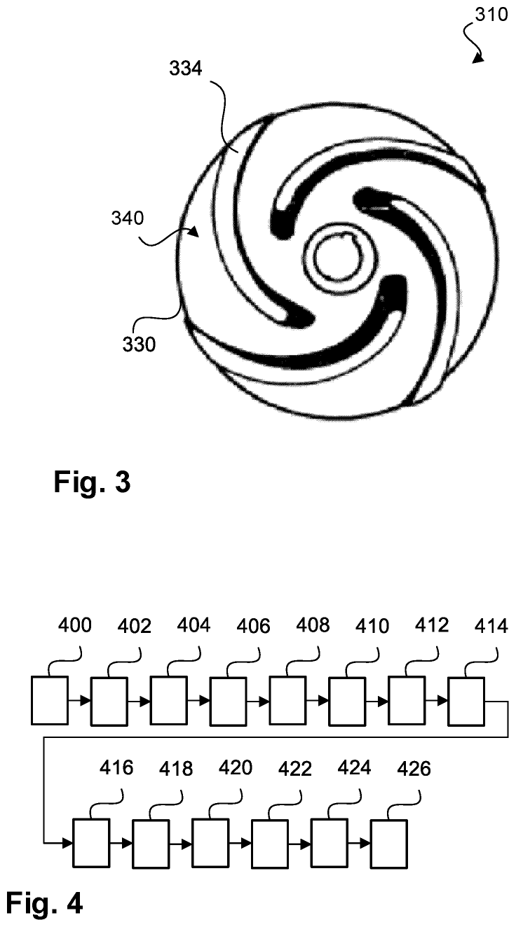

FIG. 3 schematically illustrates, for explanation purposes, an impeller 310, which is similar to impeller 210, but has an open (or semi-open) design. Impeller 310 comprises multiple vanes 334, which are arranged on a shroud or plate 230. In this way, kind of (open) channels 340 are formed between two of such vanes and the plate. As can be inferred from FIG. 3, machining of such channels 340, is feasible much better than for channels 240 of FIG. 2.

FIG. 4 illustrates, by means of a flow diagram, a method according to a preferred embodiment of the invention in a flow diagram. The method comprises different steps. In a step 400, a raw-stage of impeller part is provided. The impeller (in the raw-stage) comprises the first part 230 (see FIG. 2) and the vanes 234 arranged at the first part 230. In this raw-stage, the impeller has an open (or semi-open) design, as there is no first (or top) part 232 yet. In this raw-stage, the impeller looks like impeller 310 shown in FIG. 3. The raw-stage of the impeller is provided, in an embodiment, as wrought material part. For example, the raw-stage of the impeller is made of one of the following materials: aluminum, aluminium alloy, titanium, titanium alloy, nickel, nickel allow, stainless steel.

In a step 402, at least part of inner surfaces of the channels 240 to be formed, are machined to a final contour. In a step 404, the top sides of the vanes 234 are pre-machined. Thus, the impeller is machined to its final contour in the channels but is only pre-machined everywhere else, for example. The top side or surface of the vanes (or blades) is also only pre-machined. Pre-machining will not result in a final contour but there will remain some material to be removed by further machining. There should remain a milling allowance.

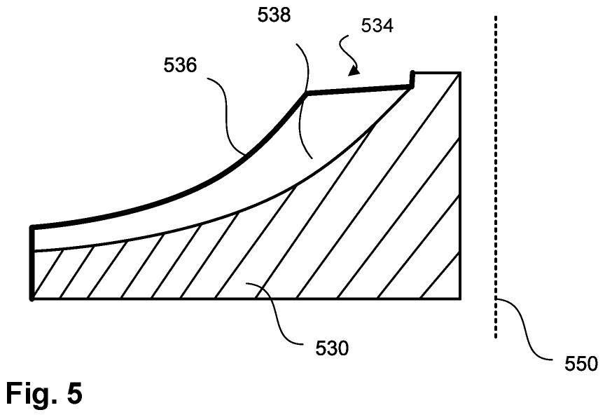

This is illustrated in FIG. 5 in more detail. Here, a sectional view of a first part 530 (shaded) with a vane 534 and rotation axis 550 (similar to first part 230 and rotation axis 250 of FIG. 2) is shown. In addition, the top side 536 of the vane and a surface 538 are shown. The surface 538 comprises side surfaces of the vane 534 and top surfaces of the first part 530, which will later be inner surfaces of a channel. This surface 538 is is machined to its final contour. The top side 536 or surface of the vane and other surfaces are only pre-machined.

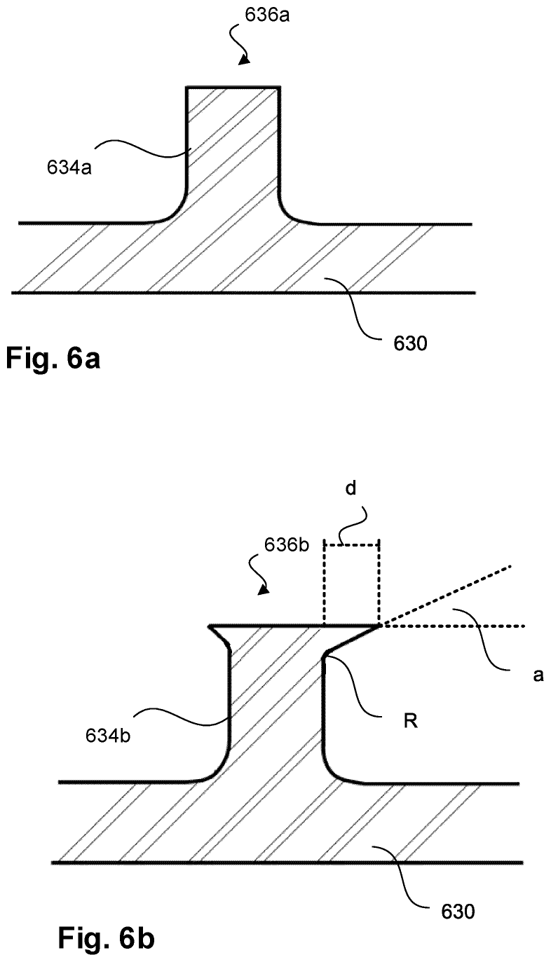

The top sides of the vanes cross section can, for example, be either rectangular as illustrated in FIG. 6a or with a flared geometry (with flares) as illustrated in FIG. 6b. FIGS. 6a and 6b show a section view of a first part 630 and a vane 634a, 634b (e.g., seen from the left of FIG. 5). The top side 636a is of rectangular shape or geometry. The top side 636b comprises a flare having a chamfer of length d with angle a prolonged by a radius R providing it is machinable by five axis milling, for example. The choice of the vanes top profile can depend on the interfacial resistance which is needed between the first part with the vanes (wrought material) and the cold sprayed second part (shroud).

In step 406, a filling material, preferably, a soluble material, is provided in spaces between the vanes. These spaces between the vanes (and surfaces of the first part, which surfaces are located between the vanes) are to become inner surfaces of the channels (preferably, after some further surface processing).

Step 406 comprises step 408, in which the spaces between the vanes are filled with the filling material, such that the filling material exceeds the top sides of the vanes, or at least reaches the top side. The filling material can be provided by means of cold spraying.

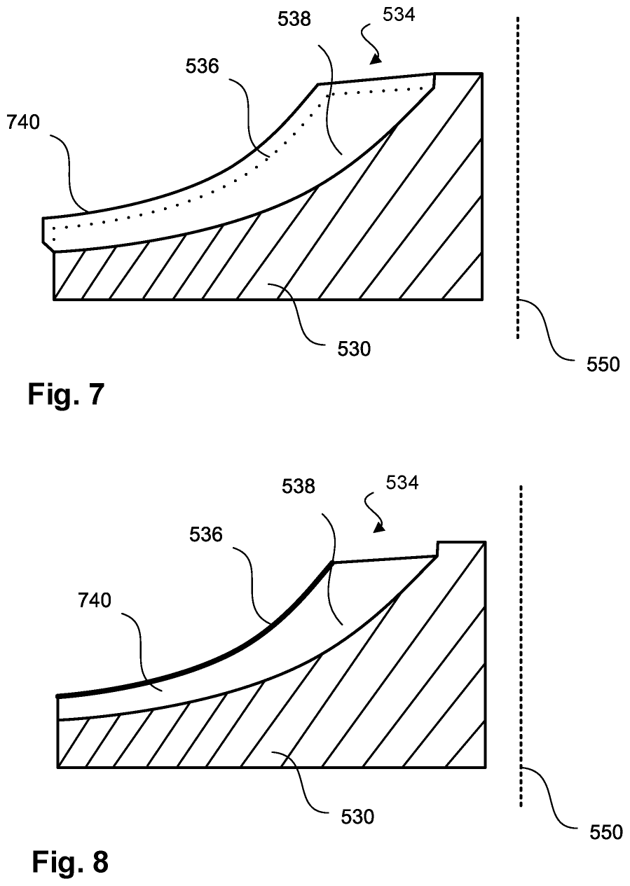

This is illustrated in FIG. 7 in more detail. FIG. 7 corresponds to FIG. 5, however, additional filling material 740 is provided between the vanes 534 and, thus, also on surface 538. It can be seen that the filling material 740 exceeds the top side 536 of the vane 534.

Step 406 further comprises step 410, in which the top sides of the vanes are machined to the final contour. Step 406 further comprises as well step 412, in which the filling material is machined at its top surface (or at at least part of it) to a contour the second part is intended to have. This is illustrated in FIG. 8 in more detail. FIG. 8 corresponds to FIG. 7, however, the top side 536, here illustrated with a bold line, has its final contour. The filling material 740 is still present. In additional step 414, remaining filling material (if any is present) can be removed from the top sides of the vanes to achieve the final contour; etching can be used here, for example. The top sides of the vanes shall be totally free of the filling material.

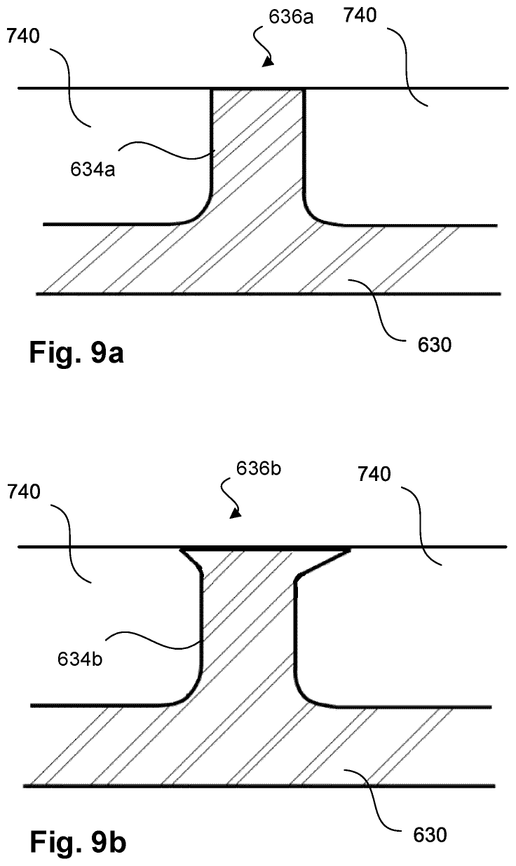

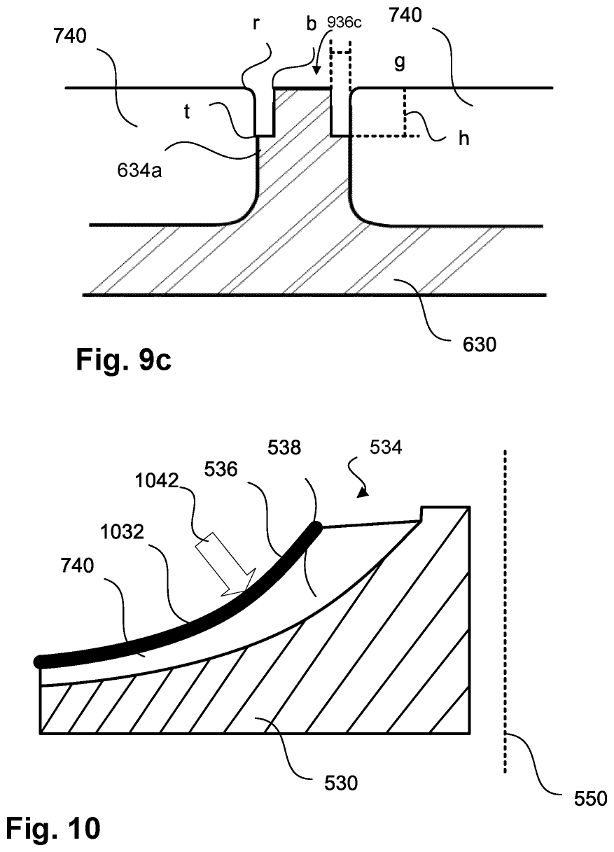

Machining of the top sides in step 410 can be performed in different ways, some of which are illustrated in FIGS. 9a, 9b and 9c. FIG. 9a corresponds to FIG. 6a, with filling material 740 provided; the top side of the vanes is rectangular. Then, the machining of the filling (soluble) material can be done on the top of the vanes only, for example.

FIG. 9b corresponds to FIG. 6b, with filling material 740 provided; the top side of the vanes is flared. Then, the machining of the filling (soluble) material can be done on the top of the vanes only, for example.

FIG. 9c shows similar view with filling material 740 provided; the top side of the vanes is rectangular. Then, the machining of the filling (soluble) material can be done on the top of the vanes and also of the sides of the vanes, for example. This results in a final contour of the top side 936c having side gaps. The shape of the side machining can depend on the interfacial resistance which is needed between the wrought material (first part and vanes) and the cold sprayed material. In particular, parameters length g of such gap, depth h of the gap, radiuses r, t and b will be determined depending on the strength required for the interface. The length g, for example must be wide enough and depth h should not be too large to allow the cold sprayed material to fill the gap entirely. In a another preferred embodiment, which is not shown, g can be as wide as to the opposite wall, therefore there would be a big gap instead of two side gaps.

The gap geometry is not limited to the geometry shown in FIG. 9c. All gap geometries which are machinable by 5-axis milling can be considered, for example. The gap in FIG. 9c is represented as rectangular but it can also be triangular, for example. What should be considered for the gap geometry definition is that the machining shall stay principally in the wrought material, not to clog the channel after having built the shroud. The only machining of the filling material which can be accepted is a radius r in the same order of magnitude as the radius existing between the blade foot and the impeller hub.

In step 416, at a top surface of the filling material and at the top sides of the vanes, the second part (shroud) is formed, preferably by means of cold spraying, preferably, with a material or an alloy whose chemical composition is either the same or compatible with a strong bonding with the wrought material

This is illustrated in FIG. 10 in more detail. FIG. 10 corresponds to FIG. 8, however, the second part 1032 (can correspond to the second part 232, see FIG. 2) is provided. The process of cold spraying is indicated by means of a spraying nozzle or gun 1042. As illustrated, the gun 1042 can be oriented perpendicular to the surface of top side 536 in order to achieve good results. Experiments have shown that spraying perpendicularly to the surface provides the best surface finish of the sprayed layer after dissolution of the filler material.

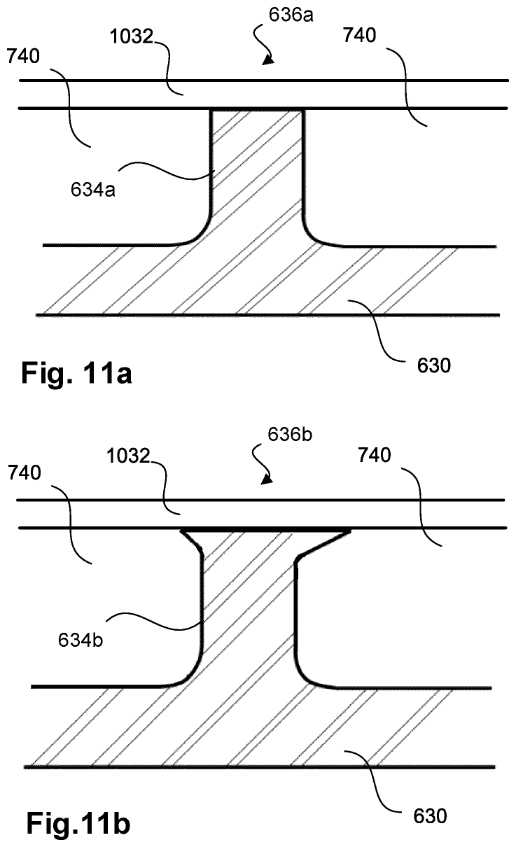

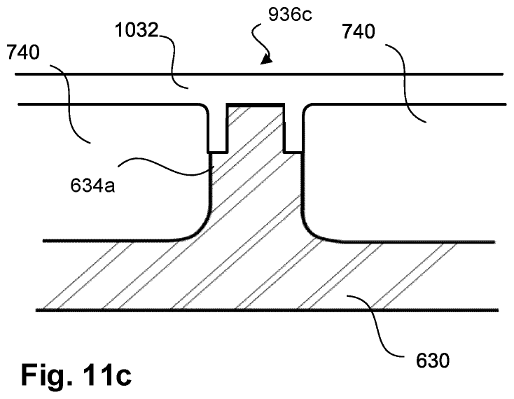

This is also illustrated in FIGS. 11a, 11b and 11c, which correspond to FIGS. 9a, 9b and 9c. FIG. 9 a, respectively. In addition, however, the second part 1032 (see FIG. 10) is also provide. In particular FIG. 11c shows that the second part is also present in the gaps.

In an optional step 418, the impeller can be heat-treated. In step 420, the filling material is removed, for example, by means of dissolving the filling material. In an optional step 422, the impeller can (again) be heated. In step 424, post-processing of inner surfaces of the channels 240 (see FIG. 2) can be performed, preferably comprising at least one of: abrasive flow machining, hirtisation, micro machining. In this way, the surface can be further improved. In step 426, the external geometry of the impeller can be finished by turning and milling.

1. A method for manufacturing an impeller, for a turbomachine, said impeller having a closed design, and said impeller comprising a first part, a second part and vanes arranged between the first part and the second part, forming channels in the impeller, the method comprising the following steps:
providing a raw-stage of the impeller, comprising the first part and the vanes arranged at the first part;
providing a filling material in spaces between the vanes;
forming, at a top surface of the filling material and at top sides of the vanes, the second part, by means of cold spraying; and
removing the filling material, and before providing the filling material:
machining at least part of inner surfaces of the channels to be formed, to a final contour; and
pre-machining the top sides of the vanes, wherein providing the filling material in the spaces between the vanes comprises the following steps:
filling the spaces between the vanes with the filling material, such that the filling material at least reaches or exceeds the top sides of the vanes, by means of cold spraying;
machining the top sides of the vanes to a final contour; and
machining the filling material at at least part of the top surface to a contour the second part is intended to have.

2. The method of claim 1, wherein providing the filling material, after machining the top sides of the vanes, further comprises: removing remaining filling material from the top sides of the vanes to achieve the final contour, preferably by means of etching.

3. The method of claim 1, further comprising, before and/or after removing the filling material: heat-treating the impeller.

4. The method of claim 1, further comprising, after removing the filling material: post-processing of inner surfaces of the channels, preferably comprising at least one of: abrasive flow machining; hirtisation; and micro machining.

5. The method of claim 1, wherein the filling material is a soluble material, and wherein removing the filling material comprises dissolving the filing material.

6. The method of claim 1, wherein the raw-stage of the impeller is provided as wrought material part.

7. The method of claim 1, wherein the raw-stage of the impeller is made of one of the following materials: aluminium; aluminium alloy, titanium; titanium alloy; nickel, nickel allow; and stainless steel.

8. The method of claim 1, wherein the second part,
obtained by means of cold spraying, is made of the same material as the raw-stage of the impeller or has a chemical composition compatible with a strong bonding with the material of the raw-stage of the impeller.

9. The method of claim 1, wherein cold spraying is performed by using a spraying orientation perpendicular to a respective surface.

10. The method of claim 1, wherein the top sides of the vanes have one of the following final contours: a rectangular geometry; a flared geometry; and a geometry with side gaps or a full gap.

11. An impeller, preferably, for a turbomachine, having a closed design, and comprising a first part, a second part and vanes arranged between the first part and the second part, forming channels in the impeller, wherein the impeller is obtained by the method of claim 1.

12. A turbomachine comprising the impeller of claim 11.
